(19) United States
(12) Patent Application Publication
(10) Pub. No.: US 2025/0282563 A1
(43) Pub. Date: Sep. 11, 2025

(54) DEVICE, ARRANGEMENT, AND METHOD FOR TRANSFERRING BALES

(71) Applicant: VOITH PATENT GMBH, Heidenheim (DE)

(72) Inventors: Frank KERN, Erftstadt (DE); Ingo JONEN, Rheinbach (DE); Stephan LIEDEMANN, Erftstadt (DE)

(21) Appl. No.: 19/216,190

(22) Filed: May 22, 2025

Related U.S. Application Data
(63) Continuation of application No. PCT/EP2023/083464, filed on Nov. 29, 2023.

(30) Foreign Application Priority Data
Nov. 30, 2022 (DE) 10 2022 131 697.1

(51) Int. Cl. B65G 47/90

(52) U.S. Cl. CPC B65G 47/905; B65G 47/902; B65G 2203/0225

(57) ABSTRACT

An arrangement, a device and a method for transferring bales. The bales, in particular bales of waste paper that are to be supplied to fiber processing, are bound with straps. Bales are picked up from a conveyor on the input side, aligned, pivoted and, if necessary tilted, and deposited on a conveyor on an output side by a transfer unit. For handling the bales, the transfer unit has a gripping unit with gripping elements. The gripping elements can be moved relative to one another and they can be moved vertically and can be rotated to tilt the bales in order to bring the straps of the bales into a preferred alignment.

### CROSS-REFERENCE TO RELATED APPLICATION

This application is a continuation, under 35 U.S.C. § 120, of copending International Patent Application PCT/EP2023/083464, filed Nov. 29, 2023, which designated the United States; this application also claims the priority, under 35 U.S.C. § 119, of German Patent Application DE 10 2022 131 697.1, filed Nov. 30, 2022; the prior applications are herewith incorporated by reference in their entirety.

### FIELD AND BACKGROUND OF THE INVENTION

The invention relates to a device for rotating and moving square bales by means of gripping arms that can be moved to the bale and automated wire position and bale shape detection, the bales being picked up by a conveyor device and transferred to the workspace of the next conveyor unit.

Waste paper, pulp, used textiles, used plastic bottles, and the like are almost exclusively delivered for processing in the form of bales, with the weight of the bales ranging between 100 and 2500 kg. The bales are generally tied with straps made of metal, plastic, or other materials.

International publication WO 2022/171640 A1A describes a method for controlling or regulating (i.e., open loop or closed loop controlling) a system with at least one conveyor belt for producing a material containing waste paper. The system comprises a measuring section, a measuring system, and a pulping device. The method involves transporting quantities of waste paper by means of a conveyor belt. A provision is made that at least one measured value of each of these quantities of waste paper, such as waste paper bales, is recorded by means of at least one optical measuring system on the measuring section along the path to the pulping device. A provision is made that the measured value is associated with at least one physical property of the quantity of waste paper and that a control value of the physical property is quantified on the basis of the at least one measured value. The method makes a provision that, in a further method step, the control value is used to control and/or regulate one or more process parameters of the system for producing a material containing waste paper.

International publication WO 2011/148037 A1 and its counterpart Austrian published patent application AT 511 873 A2 describe a device for transferring pulp bales from a sheet cutter to a bale line. The device employs a cutting conveyor trough to pick up the pulp bales in the machine direction, corresponding to the direction in which the pulp web is moving, in order to form a bale row in the transverse direction. The bale row is moved forward in the machine direction. The device has a receiving conveyor for receiving the bale row and transferring it in the machine direction, and the receiving conveyor has a width corresponding to the transverse direction and is formed by conveyor units arranged in the machine direction and separated from one another in the transverse direction by gaps. The device also has a transfer carriage whose width corresponds to the transverse direction and which can be moved forward and backward in the machine direction and is equipped with lifting devices. The lifting devices can be moved to the gaps between the conveyor units of the receiving conveyor. The device also has lifting and lowering output conveyors which transfer in the transverse direction and which are arranged in the gaps between the lifting devices.

In order to process materials supplied in bales, it is imperative that they be cut open and, depending on how they will be further processed, that the straps be removed if possible. Besides manual cutting, machines are now used for this purpose, although these require the straps to be in a specific position and orientation in order to separate and optionally remove them. Depending on the orientation of the straps, the bales may need to be aligned according to the arrangement of the blade(s) and gripper(s) before being fed to the downstream machine.

For example, international publication WO 2018/033257 A1 discloses a bale wire cutter for cutting straps of square bales by means of a plurality of cutter bars that can be moved to the bale. The bales are guided by a conveyor system into the workspace of the cutter bars. Safe and easy cutting of the straps, regardless of their position, is made possible by the fact that the conveying device is formed by at least two conveyor belts that run next to one another under the bales and that a circular blade with a rotation axis that lies transverse to the conveying direction is arranged between at least two adjacent conveyor belts.

Another device for removing straps is known from international publication WO 2004/028906 A1 and its counterpart German patent DE 10 244 382 B3.

Chinese utility model CN 208377748 U discloses a highly flexible lifting arm production line. Among other components, this highly flexible lifting arm production line comprises a crane bridge and an output line for the finished product.

Chinese patent application CN 111942834 A relates to a cotton bale transport and unloading device and belongs to the technical field of textile equipment. The device consists of industrial robots and bale arrangement trolleys. The industrial robots consist of fixed bases and mechanical arms. The movable mechanical arms are arranged on the fixed bases. Bale gripping claws are located at the rear ends of the mechanical arms and are used to carry cotton bales and remove outer packaging bags from the cotton bales.

German published patent application DE 10 2017 205 001 A1 describes a device and a method for handling moving piece goods. The device comprises a manipulator for piece goods and a transport device via which the moved piece goods are transported in a transport direction to a detection area of the at least one manipulator. A detection device for obtaining position data of an item of piece goods moving in the transport direction is arranged in an inlet area of the detection area of the manipulator and/or immediately in front of it. The detection device is used to measure weight within the inlet area. The manipulator and/or other conveyor components of the device can be calibrated and/or controlled based on the position data. The device and the method are used for the palletizable alignment of containers, in particular containers of beverage containers.

### SUMMARY OF THE INVENTION

It is therefore the object of the invention to improve the handling of square bales for fiber processing.

With the above and other objects in view there is provided, in accordance with the invention, a device for transferring square (i.e., cuboid) bales of fiber material for fiber processing, the bales being bound with straps, the device comprising:
a conveyor for conveying the bales and a lifting device for lifting the bales having the straps;
said lifting device having a gripping unit with at least a first gripping element and a second gripping element for picking up a respective bale between said first and second gripping elements;
said gripping elements being movable relative to one another and being movable vertically; and
a rotary drive for rotationally driving said gripping elements for tilting the respective bale in a picked-up position.

In other words, the invention relates to a transfer device for transferring square bales, i.e., cuboid-shaped bales. The transfer device, or simply device, according to the invention has a lifter with a gripping unit. The gripping unit has at least one first and one second gripping element for picking up a bale between the gripping elements. The gripping elements can be moved relative to one another (i.e., towards one another and away from one another. This makes it easy to secure a bale between the gripping elements. In addition, the gripping elements themselves or the entire gripping unit can be moved vertically. This enables a bale to be lifted and set down again. In order to tilt the bale, the gripping elements are driven in rotation.

Tilting is a movement of the bale about a horizontal axis of rotation perpendicular to the conveying direction relative to a horizontal conveying direction of the input-side conveyor. Tilting can ensure a preferred alignment of the straps. The preferred alignment of the strap(s) is required for subsequent removal of the strap(s). Tilting is particularly easy in a raised position in which the bale is not resting on anything. Especially preferably, the bale can be lifted high enough so that the bale can be picked up and tilted freely by the gripping elements. This enables additional friction with surrounding elements, such as a conveyor belt, to be avoided.

A pivoting movement is a movement of the bale about a vertical axis of rotation relative to a horizontal conveying direction of the input-side conveyor.

Turning the bale is a movement of the bale around a rotation axis arranged in the conveying direction relative to a horizontal conveying direction of the input-side conveyor.

The bale can be grasped by means of the gripping unit and moved in its entirety by the movement of the gripping unit. In this way, the bale can be moved in the conveying direction by means of a translational movement while its alignment is maintained. By rotating the gripping unit, a bale can be aligned with respect to a conveyor by pivoting it, and it can also be adjusted to the orientation of the output-side conveyor. This allows for a more flexible arrangement of the output-side conveyor, since an angular arrangement of the output-side conveyor can also be taken into account by means of a pivoting movement. The provision of an option for pivoting thus expands the possible uses of the device.

In one advantageous embodiment, the clamping of a bale can be detected by detecting the movement of the gripping elements relative to one another.

In an advantageous embodiment, the gripping unit can have a measuring element for detecting the weight of the gripped bale. This allows inferences to be made about the density of the bale material and/or the pollutant content thereof. In addition, it is possible to use this detected weight for subsequent pulping and production of a suspension and, in particular, to adjust the weight of dilution water added more precisely.

In accordance with an added feature of the invention, the gripping unit can be driven at least translationally and/or rotationally. The bale can be grasped using the gripping unit. Once the bale has been picked up, it can be transferred by means of a translational movement. The bale can thus be transferred from one conveyor to another.

It has proven advantageous that the transfer device have at least one linear drive for a translational movement of the gripping unit.

In accordance with another feature of the invention, the gripping unit has a U-shaped support. The gripping elements can be arranged on the legs of the support. The U-shaped support ensures high stability and makes the structure simple to assemble.

In accordance with an additional feature of the invention, each gripping element is provided with a rotary drive. Consequently, only one signal connection and one power supply are required for the rotary drive of the respective gripping element, which has a beneficial effect on the complexity of the design.

In accordance with again an added feature of the invention, the a bale picked up by the gripping elements can be pivoted by at least 90°. This makes it especially easy to change the orientation of the square bales. This means that the transfer device can be easily adapted to spatial conditions. In particular, the output-side conveyor can be arranged at an angle to the input-side conveyor.

In accordance with a preferred embodiment, a bale picked up by the gripping elements can be rotated by at least 120° about at least one of its center axes, preferably about at least two of its center axes. This enables small misalignments of the fed bales to be compensated for by the transfer device.

In an alternative embodiment, a provision is made that the gripping elements can be rotated by means of rotary drives and that the gripping unit can be pivoted. This enables the picked-up bale to be tilted in order to align the straps and for it to be pivoted in order to align it with the output-side conveyor. This multifunctionality makes the device especially flexible in its use.

In accordance with again another preferred embodiment of the invention, a detection device is provided for detecting an orientation of a strap of the bales. The detection device can also be arranged so as to be spatially separate from the transfer device. Preferably, the detection device is arranged in front of the transfer device with respect to the direction of movement of the bales. This makes it possible to use the data recorded by the recording device to control the transfer device. In particular, a detected orientation of straps can be used by the transfer device to transfer the bales.

For example, optical detection can be provided to detect orientation. In particular, sensor detection in at least two spatial directions has proven advantageous. For example, with inductive detection, interpolation can be carried out on straight sections of a strap.

In one embodiment, a provision is made that a detection device has for detecting at least one outer contour of the bales. Based on the outer contour, a center of gravity can be determined assuming a constant density. This makes it possible to ensure that the gripping elements act at the center of gravity so that no torque acts on the gripping elements. This can reduce the load on the transfer device, particularly on the drives of the gripping elements.

It has proven advantageous to provide the transfer device in an arrangement for transporting waste paper bales. The arrangement comprises an input-side conveyor and at least one output-side conveyor. The transfer device transfers bales from the input conveyor to the output-side conveyor. A predetermined spacing between the bales to be deposited on the output-side conveyor and also a predetermined alignment of straps of the bales and/or a predetermined alignment of the bales can be provided for by the transfer device. The arrangement enables the bales to be positioned in a way that is adapted to the available space. If converted, the transfer device can also be used for modified bale conveyance.

With the above and other objects in view there is also provided, in accordance with the invention, a method for aligning strapped bales using a device or arrangement as described above. The method includes the following steps:
detecting an outer contour of the respective bale;
determining a bale position;
detecting the alignment of straps of the bale;
controlling the gripping elements so as to pick up a bale on an input-side conveyor on two opposite sides of the bale;
lifting the bale depending on the orientation of straps of the bale;
translational and/or rotational movement of the bale;
depositing the bale with a predetermined orientation on the output-side conveyor.

This method provides for the positioning of the bale through movement and alignment in a raised position. This allows for precise positioning.

This method makes it possible to consider whether tilting of the bale is necessary during transfer and to adjust the vertical lifting of the bale accordingly. This reduces the energy required for the transfer. For example, if the bale needs to be tilted in order to align the straps, a greater vertical height is required to avoid contact with the conveyor during tilting.

In a preferred variant of the method, a provision is made that the dimensions of the bale to be transferred are determined as a function of a detected outer contour and, in order to avoid or at least minimize a torque acting on the gripping elements, a center position is determined on the side of the bale to be picked up by the gripping element. This enables the mechanical stresses that occur during positioning to be minimized.

In a preferred embodiment of the method:
the side lengths are determined based on the outer contour; and
stored value ranges for the side lengths of the bales are referenced.
   When the detected side length is outside the range of values for the side length, the number of bales lying one behind the other without a gap is determined as a multiple of the permissible side lengths. Based on the determined number, an average side length is determined, and based on this side length, the center of gravity is determined and used as the basis going forward.

After the traversing and depositing operation, the combined gripper-rotator unit is moved back to the starting position at the conveyor.

Other features which are considered as characteristic for the invention are set forth in the appended claims.

Although the invention is illustrated and described herein as embodied in a device, arrangement, and method for transferring bales, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a perspective view of a transfer device according to the invention;

FIG. 2 shows a side view of the transfer device;

FIG. 3 shows a sectional view of a section taken along the line A-A in FIG. 2;

FIG. 4 shows a front elevation view of the transfer device; and

FIG. 5 shows a further side view of the transfer device.

### DETAILED DESCRIPTION OF THE INVENTION

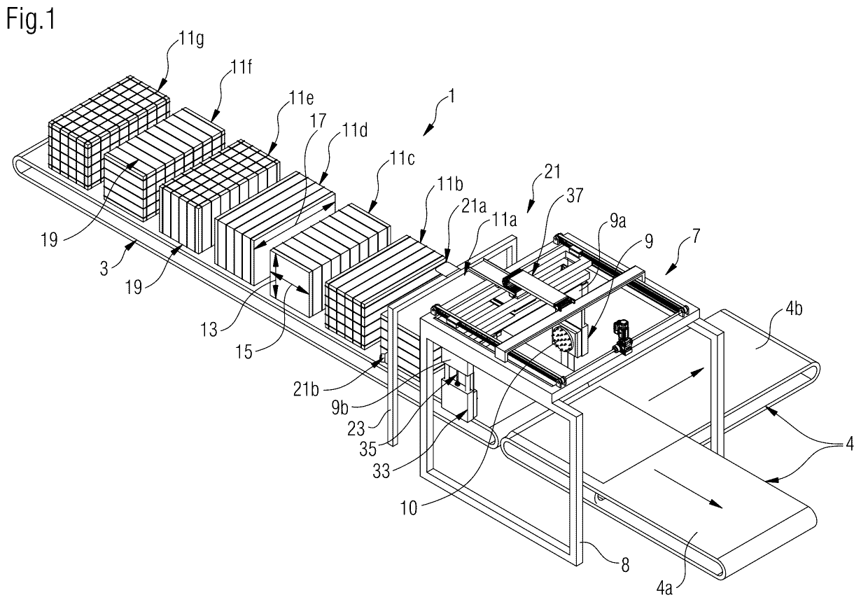

Referring now to the figures of the drawing in detail, there is shown an arrangement 1 with a transfer device 7, hereinafter also simply referred to as the device 7. Bales 19 are fed to the transfer device 7 by an input-side conveyor 3. The bales 11 are held together by straps 19. There are various possible arrangements of the straps for holding a bale together, as shown by way of example in FIG. 1. The variations are indicated by reference numerals 11a-11g. These variations are not an exhaustive representation of the possibilities. A detection device 21 is provided for detecting the position of the bales on the conveyor 3 and the contour of the bales and the orientation of the straps. The detection device 21 here has a U-shaped support 23.

An upper sensor 21a is arranged on the support 23 above the conveyor 3 for detecting the bale 11 located on the conveyor, looking downward for a plan view. From this perspective, the bale length 17 and also the bale width 15, as well as an oblique orientation of the bale 11 on the conveyor 3 can be detected. Lateral sensors 21b are arranged on each side next to the input-side conveyor 3. From this perspective, the bale height 13 and the bale width 15 can be detected. In addition, the two lateral sensors can detect an oblique alignment of the respective bale. The detection device 21 can detect the straps and the orientation thereof. The bales 11 still on the conveyor are picked up individually by a transfer device 7 and fed to an output-side conveyor 4. The structure and operation of the transfer device 7 will be described in detail below.

As can be seen from FIG. 1, the output-side conveyor 4 can have different orientations. Shown here are an arrangement in extension 4a of the input-side conveyor 3 and an arrangement 4b perpendicular to the input-side conveyor 3. Optical detection is provided for here in the form of the sensors 21a, 21b. The data recorded by the detection device 21 are fed to a control device or controller. Data processing takes place in the control unit. The detection device 21 is arranged so far in front of the transfer device 7 that data processing takes place before the corresponding bale 11 arrives in the transfer device 7.

The transfer device has a gripping unit 9. The gripping unit 9 is arranged within a support structure 8 of the transfer device 7. Here, the gripping unit 9 comprises two legs 9a and 9b. Each leg supports a gripping element 10. The two gripping elements 10 are arranged so as to be oppositely situated and they can be moved toward and away from one another. In the exemplary embodiment, it is the legs 29 of the gripping unit 9 that are driven for the linear movement of the gripping elements. It is also possible for the gripping elements 10 themselves to be moved. By moving the gripping elements 10 toward one another, a bale 11 located between the gripping elements 10 is clamped between the gripping elements 10.

A lifting drive 35 moves the gripping elements 10 upward and lifts the bale 11. Depending on the desired final position, the bale 11 held by the gripping elements 10 can now be turned, pivoted, and tilted. In particular, tilting can be provided for in order to align the straps. A target alignment of the straps can be stored in the control device for this purpose. Different target alignments can also be stored for different strapping processes. Pivoting, or rotation, can be provided for in order to adapt to the alignment of an output-side conveyor 4b. Besides the right angle shown here between conveyors 3 and 4b, the conveyors can also be arranged at any angle to one another. To feed the bale 11 and deposit the bale 11 on the output-side conveyor, the gripping unit is moved linearly in the conveying direction relative to the input-side conveyor 3. The linear drive 37 is provided for this deflection of the gripping unit. The drive 39 is provided for the rotation of the gripping unit 9.

The square bales 11a, 11b, 11c, 11d, 11e, 11f, 11g, consisting for example of waste paper, are transported by an input-side conveyor 3, here in the form of a conveyor belt, into the transfer device 7. The bales may also be referred to as cuboid bales.

There, the bales can be gripped by a combined gripping/turning unit. The bales 11a, 11b, 11c, 11d, 11e, 11f, 11g can have straps 19 with different orientations. These straps need to be identified and evaluated.

The basis is a sensor-based detection of the bales and is optical in nature. Specifically, these are the bale position, bale height, width and length, and the surface 18. This information is passed on to an evaluation unit of a control device. The recorded actual position of the bale is compared with a stored target position. From the recorded contour of the respective bale, a gripping position is determined in the control device and used to determine the gripping position and the necessary rotations.

After evaluation, the device grabs the frontmost bale, lifts the bale, transports the bale, and deposits the bale at a defined position on the output-side conveyor belt 4. To cut the straps 2, the bales 11a, 11b, 11c, 11d, 11e, 11f, 11g are conveyed by the output-side conveyor belt 4 for further processing to a downstream processing unit, e.g., a wire cutting machine (wire cutter) or a dewiring machine. After the bale 11a, 11b, 11c, 11d, 11e, 11f, 11g has been deposited, the gripping unit 9 is returned to a home position.

The most important features of the arrangement 1 are the consideration of the strap position and the optical detection of the bales 11 and the strap position.

As an additional feature, the bales are measured using sensors. This is a prerequisite for the correct positioning of the gripping unit 9, as well as for the safe moving and turning/pivoting and tilting of the bales.

To detect the bales and the orientation of the strap, as noted, the sensor 21a is optical in nature, but not necessarily exclusively. Additional detection technology may be employed. The sensor or sensors are connected upstream of the actual transfer device. At least one additional sensor 21a and/or 21b may be provided for detecting the strap orientation.

At least one additional possibility for rotation by the drive 39 of the gripping unit above the bale enables the bale to be pivoted in the conveying direction and increases the possible applications of the machine with regard to a flexible arrangement of the conveyors 3 and 4 to one another.

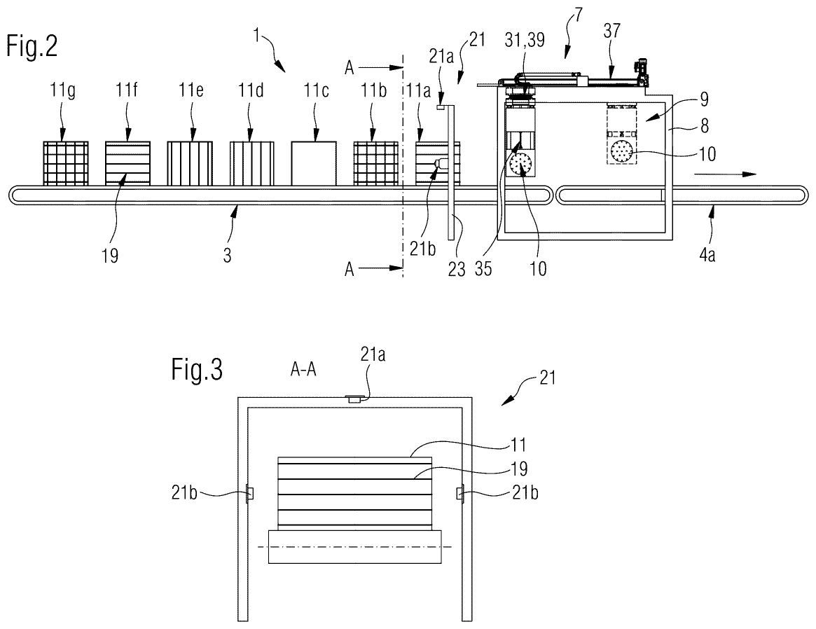

FIG. 2 shows the arrangement according to FIG. 1 from the side. The gripping unit 9 is shown in two different positions. In the position facing toward the input-side conveyor 3, the gripping unit 9 is positioned to pick up a bale 11. In the second position shown in dashed lines above the output-side conveyor 4a, the gripping unit 9 is in a position before placement of the corresponding bale 11. The bale 11 is still being held above the conveyor 4a by the gripping elements 10. For placement on the conveyor 4a, the lifting drive 35 is activated, and the bale is deposited on the output-side conveyor 4a.

The detection device 21 is shown in FIG. 3. The support 23 is U-shaped and carries the laterally positioned sensors 21b and the upper sensor 21a. These sensors can detect the positioning of the straps. The signals are passed to a control device or controller for evaluation.

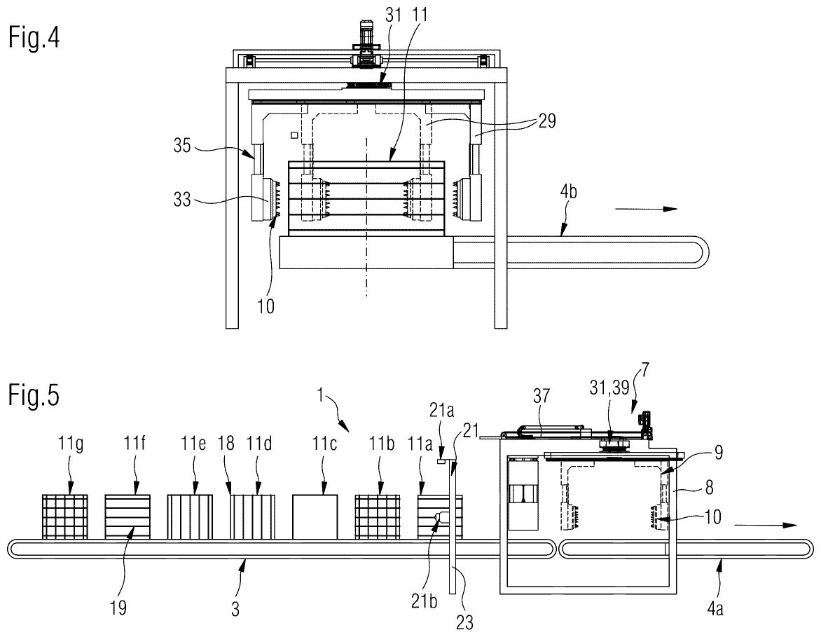

FIG. 4 shows the transfer device with an output-side conveyor 4b arranged at a 90° angle. The gripping elements 10 are shown in a maximum outer position. Starting from this position, the legs 29 of the gripping unit 9 are moved toward one another, and the bale 11 is clamped and held between the gripping elements 10. A position of the gripping elements 10, in which the gripping elements 10 are shown in a closed position, is shown in dashed lines. In this position, a bale 11 lying in the conveying direction of the input-side conveyor 3 can also be picked up.

FIG. 5 shows an arrangement 1 in which the gripping unit 9 has been rotated by 90° for the purpose of depositing a bale 11. The bales are then placed in longitudinal alignment on the output-side conveyor 4a. The linear drive 37 is provided for the translational movement of the gripping unit 9. The rotary drive 39 is provided for the rotation of the gripping unit. The gripping elements can be driven rotationally by the gripping drive.

The following is a summary list of reference numerals and the corresponding structure used in the above description of the invention:
1 arrangement
3 conveyor, input side
4 conveyor, output side
4a conveyor, straight
4b conveyor, right angle
7 device/transfer device
9 gripping unit
10 gripping element
11 bale
11a-11g bales with different strapping
13 bale height
15 bale width
17 bale length
18 bale surfaces/outer contour of the bales
19 strap
21 detection device
21a sensor, top
21b sensor, side
23 support of 21
29 leg of gripping unit
31 gripping drive for moving together
33 gripping drive for rotating the gripping element
35 lifting drive
37 drive for moving gripping unit
39 drive for rotating gripping unit

1. A device for transferring square bales of fiber material for fiber processing, the bales being bound with straps, the device comprising:
a conveyor for conveying the bales and a lifting device for lifting the bales having the straps;
said lifting device having a gripping unit with at least a first gripping element and a second gripping element for picking up a respective bale between said first and second gripping elements;
said gripping elements being movable relative to one another and being movable vertically; and
a rotary drive for rotationally driving said gripping elements for tilting the respective bale in a picked-up position.

2. The device according to claim 1, wherein said gripping unit is configured to be driven at least one of translationally or rotationally for pivoting the in the picked-up position.

3. The device according to claim 1, wherein said gripping unit is configured to pivot a bale that has been picked up by said gripping elements by at least 90° about a vertical axis of rotation.

4. The device according to claim 1, wherein said gripping unit is configured to pivot a bale that has been picked up by said gripping elements by at least 90°.

5. The device according to claim 4, wherein said gripping unit is configured to pivot the bale that has been picked up by said gripping elements by at least 120°.

6. The device according to claim 1, which further comprises a detection device for detecting an orientation of a strap of the bales.

7. The device according to claim 1, wherein each gripping element has a rotatory drive.

8. The device according to claim 1, which further comprises a detection device configured for detecting an outer contour of a bale to be picked up in order to determine a desired contact point for the respective said gripping element on the bale.

9. An arrangement for transporting bales, the arrangement comprising:
a device for transferring bales according to claim 1;
an input-side conveyor and at least one output-side conveyor for transporting the bales to and away from said device for transferring the bales;
said device for transferring the bales being configured for at least one of aligning the bales in a predetermined transport direction or aligning the bales for a predetermined alignment of a strap of the bales.

10. A method for aligning bales that are provided with straps, the method comprising:
providing a device for transferring bales according to claim 1;
detecting an outer contour of a respective bale;
determining a bale position of the bale;
detecting an alignment of straps of the bale;
controlling the gripping elements of the device for transferring bales to pick up the bale from the input-side conveyor on two mutually opposite sides of the bale;
lifting the bale depending on the alignment of the straps of the bale;
selectively moving the bale in translation and/or in rotation; and
depositing the bale with a predetermined orientation on an output-side conveyor.

11. The method according to claim 10, which comprises determining dimensions of the bale to be transferred as a function of the detected outer contour, and detecting a center position on a side of the bale to be picked up by the gripping element in order to prevent a torque from acting on the gripping elements.

12. The method according to claim 10, which comprises determining a center of gravity of the bale to be picked up, assuming a constant density throughout the bale volume.

13. The method according to claim 10, which comprises:
determining side lengths of the bale based on the outer contour;
referencing stored value ranges for the side lengths of the bales;
picking up bales on the input-side conveyor without any spacing; and
controlling the gripping unit for picking up a single bale by the gripping elements on mutually opposite sides.

14. The method according to claim 13, which comprises controlling the gripping elements for a central gripping on opposite side surfaces of the single bale, and thereby assuming a determined average edge length of the bales resting against one another.
